(19) United States
(12) Patent Application Publication
(10) Pub. No.: US 2019/0018906 A1
(43) Pub. Date: Jan. 17, 2019

(54) Systems and Methods for Organizing Materials Relating to a Project

(71) Applicant: Kristina Johnson, Midland, TX (US)

(72) Inventor: Kristina Johnson, Midland, TX (US)

(21) Appl. No.: 16/032,160

(22) Filed: Jul. 11, 2018

Related U.S. Application Data
(60) Provisional application No. 62/531,210, filed on Jul. 11, 2017.

(51) Int. Cl. G06F 17/30; G06F 3/0482

(52) U.S. Cl. CPC G06F 17/30994; G06F 17/30991; G06F 3/0482; G06F 17/30849; G06F 17/30274

(57) ABSTRACT

Systems and methods for organization may be provided, such as for when building a home or tackling a remodeling project. A user may have the ability to upload and tag images of selections, track the budget for a home project, manage the timeline, print or otherwise transmit spec sheets to an architect or builder, export the project to another platform, and/or share the project with others using an Internet-based application. The application may be a mobile application that may be accessed by a user over the Internet via his/her mobile phone or tablet. Accordingly, a user may access information related to the home building or remodeling project while on the go, such as at the home site, during meetings with builders/architects/interior designers, and/or at a home goods store when searching for materials related to the project.

### CROSS-REFERENCE TO RELATED APPLICATION

This application claims the benefit under 35 U.S.C. § 119(e) of U.S. Provisional Patent Application No. 62/521,210 filed on Jul. 11, 2017, entitled “Systems and Methods for Organizing Materials Relating to a Home Building or Remodeling Project,” which is incorporated by reference in its entirety.

### FIELD OF THE DISCLOSURE

The present disclosure generally relates to organizing materials, and more particularly to organizing and managing materials relating to a project such as a home building or remodeling project.

### BACKGROUND

It is sometimes difficult to keep track of information, including budget, timeline, designs and inspirational images, related to a home building or remodeling project. The information can originate from different sources that need to be integrated to ensure a successful project. Further, storage and later retrieval/sharing/management of the information—even when stored in digital form—can present challenges.

### SUMMARY

It is sometimes difficult to keep track of information, including budget, timeline, designs and inspirational images, related to a home building or remodeling project. The information can originate from different sources that need to be integrated to ensure a successful project. Further, storage and later retrieval/sharing/management of the information—even when stored in digital form—can present challenges.

Systems and methods according to embodiments of the present disclosure may provide an Internet-based application for a user to keep track of information, including budget, timeline, designs and inspirational images, related to a home building or remodeling project. The information can originate from different sources and can be integrated within the Internet-based application to ensure a successful project. Using the application, information may be stored for later retrieval/sharing/management of the information. A user may upload and tag images of selections, track the budget for a home project, manage the timeline, print or otherwise transmit spec sheets to an architect or builder, export the project to another platform, and/or share the project with others using an Internet-based application. Accordingly, using an application according to embodiments of the present disclosure, a user may access information related to the home building or remodeling project while on the go, such as at the home site, during meetings with builders/architects/interior designers, and/or at a home goods store when searching for materials related to the project.

Embodiments of the present disclosure may provide an Internet-based method for organization relating to a home building or remodeling project comprising: identifying the home building or remodeling project from a list of one or more projects within a mobile application accessible via the Internet; customizing a plurality of topics relating to the home building or remodeling project; uploading one or more images or videos; associating the one or more images or videos with at least one of the plurality of topics and at least one physical location within the at least one of the plurality of topics; and viewing at least one view of the home building or remodeling project, the at least one view selected from the group comprising: a timeline view to show days that have passed since the home building or remodeling project began or days remaining before scheduled to be finished, a sanity view to provide other users working on the home building or remodeling project a real-time indication as to how a user feels about the home building or remodeling project, and a budget view. The plurality of topics may be pre-loaded within the mobile application. Customizing topics may include adding additional topics. The one or more images or videos may be uploaded to the mobile application via a user's camera within his/her mobile phone or tablet. The method also may include viewing at least one of the one or more images or videos based on the plurality of topics or the at least one physical location; and commenting on the at least one of the one or more images or videos. The method may further include sharing the home building or remodeling project with at least one other user via the mobile application accessible via the Internet. The method may include producing at least one specification sheet based on the plurality of topics, the one or more images or videos, and the at least one physical location relating to the home building or remodeling project. The one or more projects may be sorted between a user's projects and projects that have been shared with the user by at least one other user. The at least one physical location may be selected from the group comprising: entry, exterior, master bedroom, great room, master bathroom, guest bathroom, guest bedroom, kitchen, laundry room, mud room, spare bedroom, child's bedroom, and staircase. The plurality of topics may be selected from the group comprising: countertops, flooring, hardware, furniture, windows, ceiling treatments, floor plan sketches, glass and mirrors, lighting, inspirational images, and doors.

Other embodiments of the present disclosure may include an Internet-based method for organization relating to a project comprising: identifying the project from a list of one or more projects through a graphical user interface within a mobile application accessible via the Internet, wherein the project includes one or more sub-categories; uploading one or more images or videos to the project; tagging the one or more images or videos to the one or more sub-categories within the project; and sorting the one or more images or videos based upon defined parameters for the project, wherein the project may be selected from the group comprising: recipes, family photographs and/or videos, video and/or photographs from friends, clothing, accessories, vacation or event places, décor or furnishing categories, personal data management categories, and interconnected projects and categories. The one or more projects may be user-defined or administrator-defined. The method may further include conducting multi-level searches of the one or more projects and the one or more sub-categories to locate one or more images or videos within the mobile application.

Further embodiments of the present disclosure may be directed to an Internet-based method for organization relating to a home building or remodeling project comprising: identifying the home building or remodeling project from a list of one or more projects within a mobile application accessible via the Internet, wherein the one or more projects are sorted between a user's projects and projects that have been shared with the user by at least one other user; customizing a plurality of topics relating to the home building or remodeling project; uploading one or more images or videos, wherein the one or more images or videos are upload to the mobile application via a user's camera within his/her mobile phone or tablet; associating the one or more images or videos with at least one of the plurality of topics and at least one physical location within the at least one of the plurality of topics; viewing at least one of the one or more images or videos based on the plurality of topics or the at least one physical location; and commenting on the at least one of the one or more images or videos. The method also may include viewing a timeline view of the home building or remodeling project to show days that have passed since the home building or remodeling project began or days remaining before scheduled to be finished. The method may further include viewing a sanity view to provide other users working on the home building or remodeling project a real-time indication as to how a user feels about the home building or remodeling project. The method may include viewing a budget view to track and manage the budget relating to the home building or remodeling project. The method may also include sharing the home building or remodeling project with at least one other user via the mobile application accessible via the Internet. The one or more images or videos and comments may originate from more than one source.

### BRIEF DESCRIPTION OF THE DRAWINGS

For a more complete understanding of this disclosure, reference is now made to the following description, taken in conjunction with the accompanying drawings, in which:

FIGS. 1A-1D depict screenshots for customization of selections according to an embodiment of the present disclosure;

FIGS. 2A-2F depict screenshots for uploading and tagging images according to an embodiment of the present disclosure; and

FIGS. 3A-3F depict screenshots of systems and methods to view images and make comments according to an embodiment of the present disclosure.

### DETAILED DESCRIPTION

Embodiments of the present disclosure may provide systems and methods for organization when building a home or tackling a remodeling project. Systems and methods may provide a user with the ability to upload and tag images of selections, track the budget for a home project, manage the timeline, print or otherwise transmit spec sheets to an architect or builder, export the project to another platform, and/or share the project with others using an Internet-based application. The application may be a mobile application that may be accessed by a user over the Internet via his/her mobile phone or tablet. Accordingly, a user may access information related to the home building or remodeling project while on the go, such as at the home site, during meetings with builders/architects/interior designers, and/or at a home goods store when searching for materials related to the project.

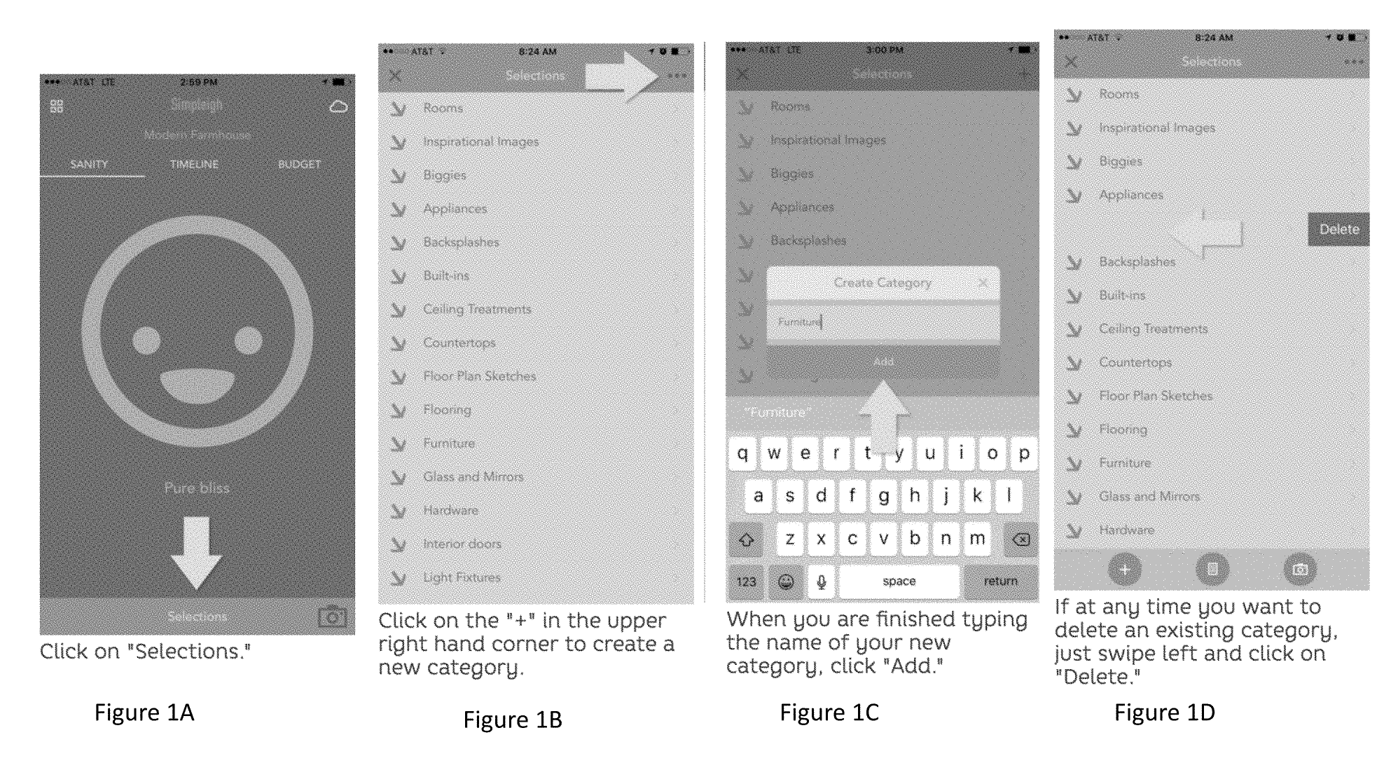

Embodiments of the present disclosure may allow a user to keep track of materials and inspirational designs as a home building or remodeling project develops. In some embodiments of the present disclosure, the application may be pre-loaded with selections, and a user may customize topics that he/she wishes to add or delete those that the user may not need. Users may add or delete selections of items including, but not limited to, furniture, art or shower details. For example, if the application is being used for a bathroom remodeling project, the user may not need to select art or furniture for the bathroom, and accordingly, the user may delete certain pre-loaded selections for that project. On the other hand, if the user is embarking on a home building project, the user may need to utilize all pre-loaded selections, and perhaps may wish to add additional selections. This customization of selections may be done on a project-by-project basis, as illustrated in more detail in FIGS. 1A-1D.

FIGS. 1A-1D depict screenshots for customization of selections according to an embodiment of the present disclosure. A “selections” button or input mechanism may be provided in FIG. 1A, and a user may select the “selections” button. In FIG. 1B, a user may be presented with a plurality of topics from which to select. These topics may include, but are not limited to, rooms, inspirational images, biggies, appliances, backsplashes, built-ins, ceiling treatments, countertops, floor plan sketches, flooring, furniture, glass and mirrors, hardware, interior doors, and light features. A user may add a topic or category by selecting the “+” symbol or another input mechanism that may be presented on the screen. A pop-up input box may be presented such as is depicted in FIG. 1C, and the user may enter a new category through a keyboard. However, other input mechanisms, including but not limited to, voice input and drop-down menus, may be used to enter a new category without departing from the present disclosure. When the user finishes enter the name of his/her new category, the “add” button may be selected. FIG. 1D depicts a mechanism for deleting an existing category according to an embodiment of the present disclosure. In this embodiment, a user may swipe left and click on the “delete” button; however, other mechanisms for deletion may be utilized without departing from the present disclosure.

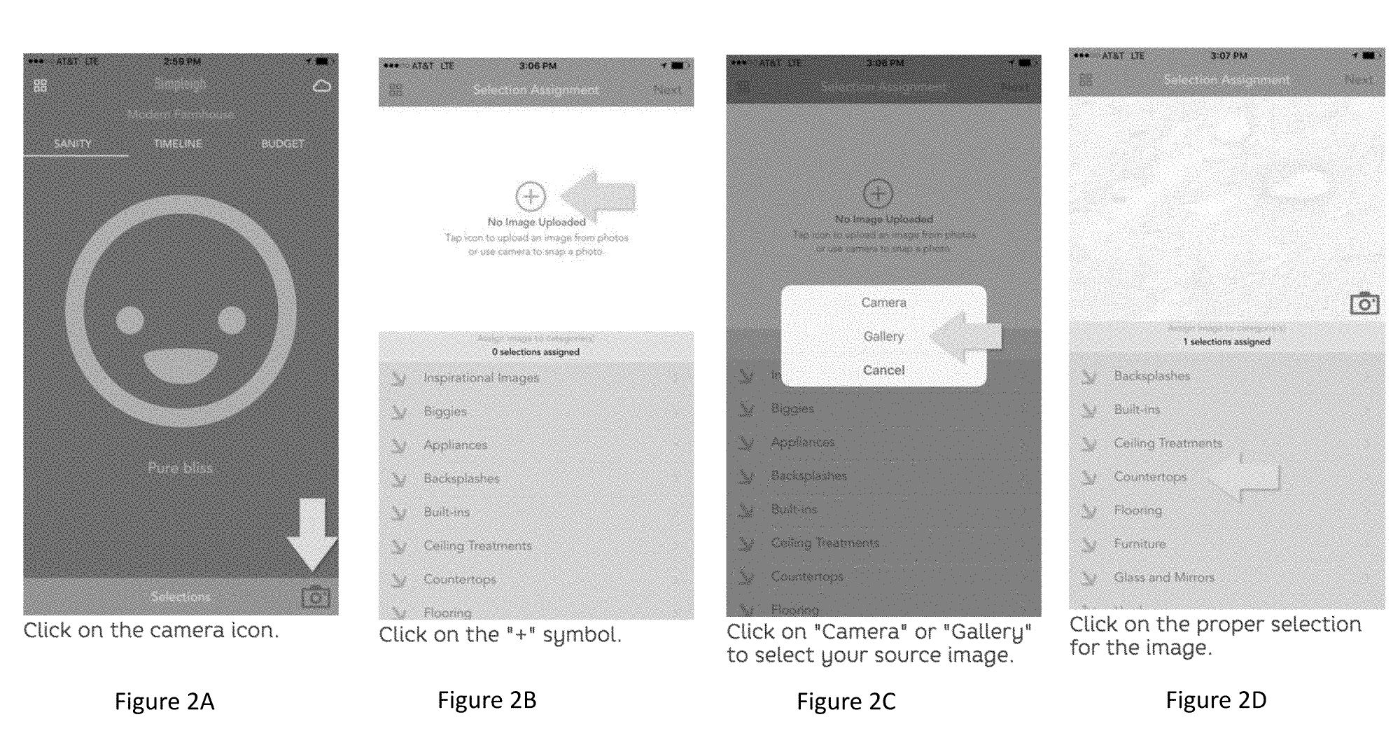

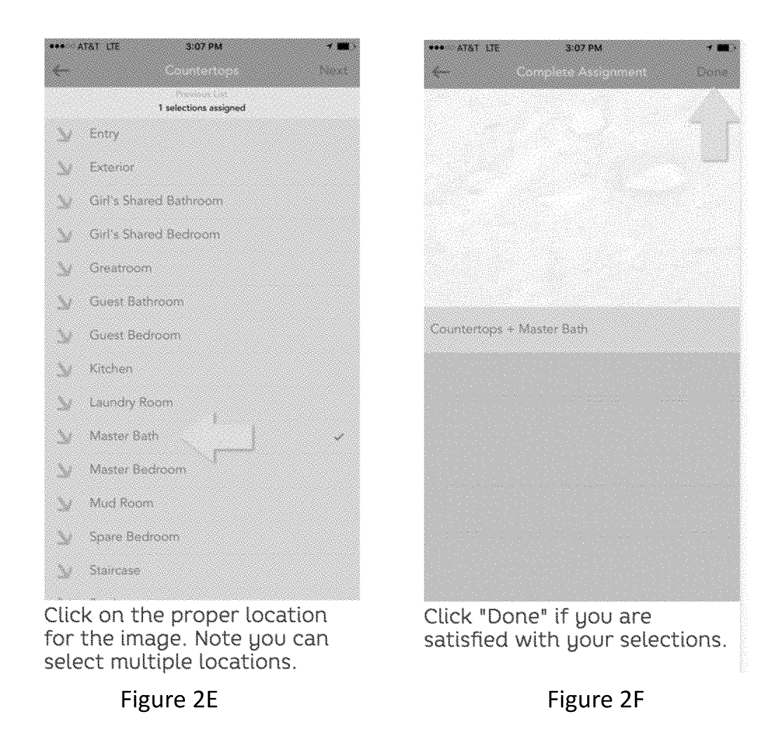

During a home building or remodeling project, it is important for selections to be organized. Systems and methods according to an embodiment of the present disclosure may provide a user with the ability to upload and tag his/her images so that they may be retrieved at a later time during the building or remodeling project. FIGS. 2A-2F depict screenshots for uploading and tagging images according to an embodiment of the present disclosure. In FIG. 2A, a user may select an option to utilize camera on his/her phone. As depicted in FIG. 2B, no image has been uploaded, but a user may click on the “+” symbol or otherwise tap/select an icon to upload an image from photos saved by the user. Additionally or alternatively, the user may use the camera on his/her phone to take a photo to be utilized. In FIG. 2C, the user may be presented with one or more options to select an image to be uploaded. In this embodiment of the present disclosure, the user may select “camera” or “gallery” to select the source image. On an image has been selected, in FIG. 2D, the user may select one or more categories to associate with the image. In this embodiment of the present disclosure, the user may assign the image to the “countertops” category. Once a category has been selected, the user may be presented with one or more locations within the category to associate the image. As depicted in FIG. 2E, the user may select the “master bath” location in the “countertops” category to associate the image. It should be appreciated that the user may select more than one location to associate the image (i.e., if the user wishes to use the same countertop in the “master bath” location as well as in the “girl's shared bathroom” and/or “guest bathroom” locations). After the user has associated the image with one or more categories and one or more locations, the user may lock in the selections in FIG. 2F, such as by selecting the “done” button when the user is satisfied with his/her selections.

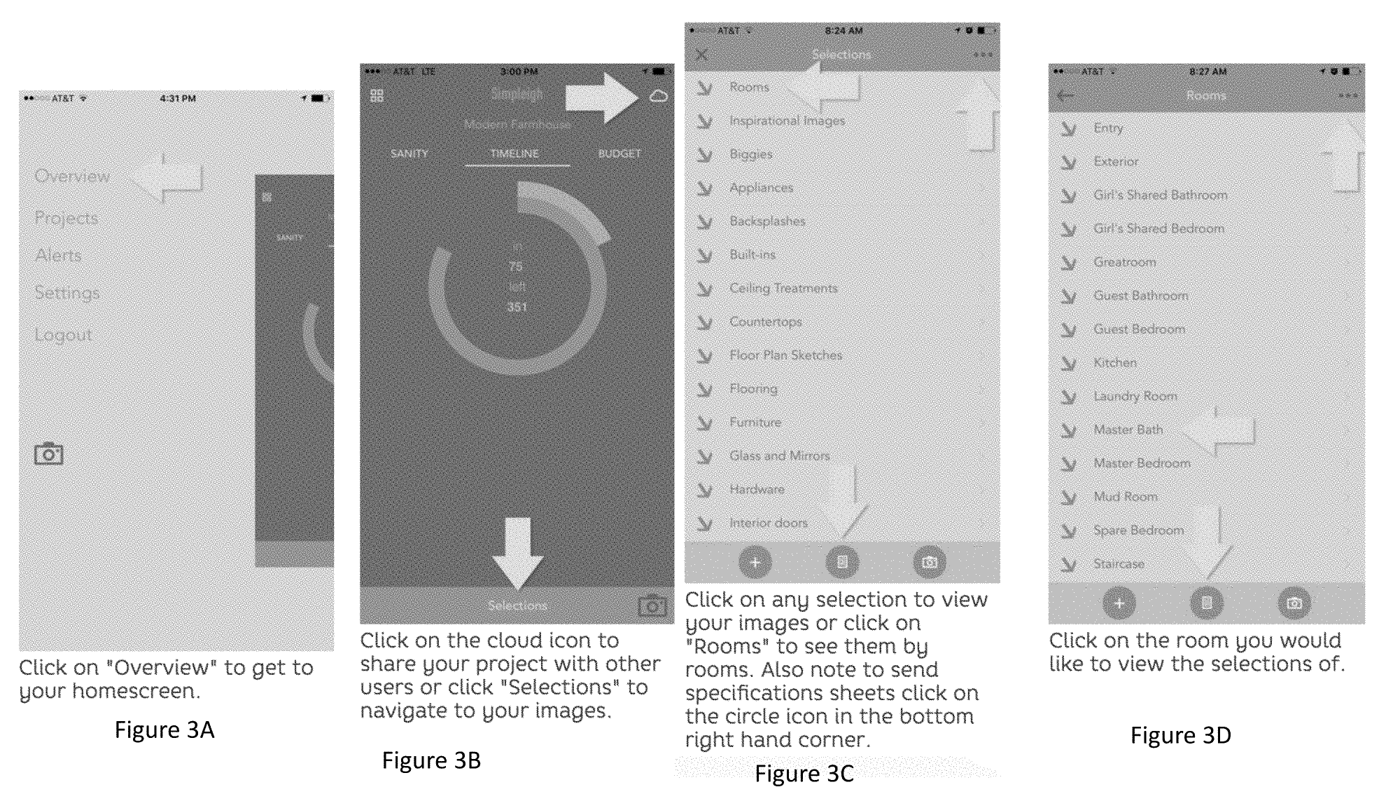

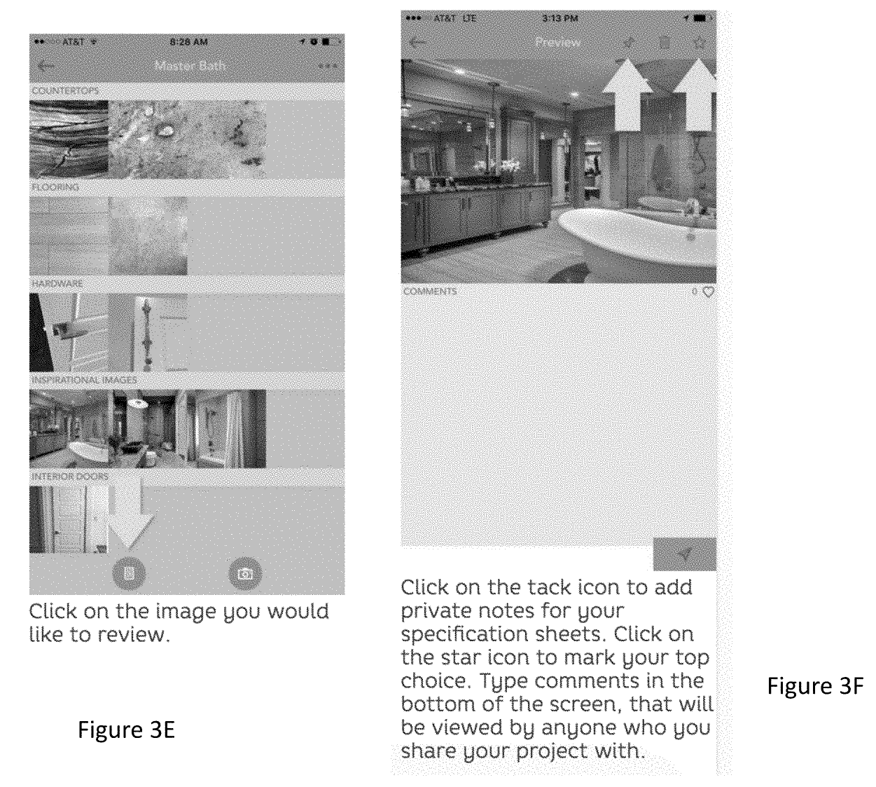

Systems and methods according to embodiments of the present disclosure may allow a user to view images and make comments. A user may view images by topic and/or by room, add notes and comments, export the project to another platform, share his/her project with other users, and/or produce specification sheets that may be printed or otherwise transmitted. FIGS. 3A-3F depict screenshots of systems and methods to view images and make comments according to an embodiment of the present disclosure. In FIG. 3A, a user may be presented with one or more selections including, but not limited to, “overview,” “projects,” and “alerts.” A user may select the “overview” button to get to his/her home screen within the application. FIG. 3B will describe further what is depicted when the user selects the “overview” button. If there is an alert associated with one or more projects, those alerts may be viewed by selecting the “alerts” button. It should be appreciated that the alerts may be organized by project or by other categories of alerts without departing from the present disclosure.

When a user selects the “projects” button depicted in FIG. 3A, the user may be presented with one or more projects. These projects may be sorted between the user's own projects and projects that have been shared with the user by others. If the user selects one of his/her own projects, the user may be directed to the home screen associated with that project. When the user selects a project that has been shared, the user may be presented with one or more categories associated with the project. For example, if a home building project has been shared with the user, the user may be able to view one or more categories including, but not limited to, rooms, inspirational images, backsplashes, light fixtures, and countertops. If the user selects the “rooms” category, for example, the user may then be presented with a list of rooms. One of the rooms may be the entry, and upon selection of “entry,” the user may be able to view images of ceiling treatments, flooring, glass and mirrors and hardware that another user has selected for his/her home building project. The user may be inspired by the other user's selections and could inquire with the other user about the selection. Additionally or alternatively, the user may provide comments to the other user about his/her selections. It should be appreciated that the other user's selections may be organized based on his/her top choice as well as other options in some embodiments of the present disclosure. It also should be appreciated that when the user is viewing the images of another user, the user also may be able to view the other user's comments on the images in some embodiments of the present disclosure.

FIG. 3B depicts a home screen within the application. This home screen may present the user with one or more views of a given project including, but not limited to, “sanity,” “timeline” and “budget.” FIG. 3B depicts the “timeline” view according to an embodiment of the present disclosure. A graphic may be provided that may show the user how many days have passed since the project began and/or how many days are remaining before the project is scheduled to be finished. It should be appreciated that the user may alter the timeline associated with the project in some embodiments of the present disclosure. Alterations may include changing the start date and the end date associated with the project.

The “sanity” view may allow the user to indicate how he/she is feeling about the project in real-time. In embodiments of the present disclosure, word descriptions and/or images may be selected to indicate the user's feelings about the project. These feelings may include, but are not limited to, “pure bliss,” “in the zone,” “holding it together,” “starting to lose my mind,” and/or “take me to the crazy house.” By allowing the user to change his/her “sanity” status in real-time, the user may give others working on the project (i.e., the architect, interior designer, and/or builder) an indication about how the user is feeling about the project. This may permit others to take actions to improve the user's feelings about the project, should the user's feelings need to be improved.

The “budget” view on the home screen may allow the user to enter the budget allotted for the project. The user also may enter/update expenses using this view. As expenses are updated, the user may be presented with a graphical representation of how the expenses are tracking relative to the budget. This “budget” view also may include numerical indicators of how much of the budget has been spent.

A user may be presented with an icon, such as the cloud icon depicted in FIG. 3B, and upon selection of that icon, the user may share his/her project with one or more users. The user may invite other users to view his/her project, and in some embodiments of the present disclosure, the other users may be prompted to download the application in order to be able to view the project (i.e., if they are new users). Selection of the cloud icon also may allow the user to see with whom he/she has shared the project. The user also may be presented with a “selections” icon to navigate his/her images within the application according to an embodiment of the present disclosure. While the cloud icon and the “selections” button are depicted in FIG. 3B, it should be appreciated that other icons or input mechanism may be utilized to allow the user to share his/her project and navigate his/her images respectively without departing from the present disclosure.

When a user selects the “selections” button in FIG. 3B, the user may be presented with a “selections” screen as depicted in FIG. 3C. The user may be presented with a “rooms” selection so that the user may view his/her images as they are organized based on the room. Additionally or alternatively, the user may be presented with categories including, but not limited to, inspirational images, biggies, appliances, backsplashes, built-ins, ceiling treatments, countertops, floor plan sketches, flooring, furniture, glass and mirrors, hardware, and interior doors. Upon selecting one of the categories, the user may view the images that have been associated with that category.

As depicted in FIG. 3C, user also may be presented with one or more additional icons, including, but not limited to, the “+” icon, the “camera” icon, and the “sheet” icon, in order to perform one or more additional functions. The “+” icon may allow the user to add more selections. The “camera” icon may allow the user to add additional images, either by taking a picture using the phone camera or by selecting one or more images from the image library. The “sheet” icon may be used for the user to send one or more specification sheets associated with the project.

When a user opts to view images by room, the user may be presented with a list of rooms associated with the project as depicted in FIG. 3D. It should be appreciated that the list of rooms may change depending on the type of project. In this embodiment of the present disclosure, the rooms may include, but are not limited to, entry, exterior, girl's shared bathroom, girl's shared bedroom, greatroom, guest bathroom, guest bedroom, kitchen, laundry room, master bath, master bedroom, mud room, spare bedroom, and staircase. Again, as discussed with respect to FIG. 3C, the user may be presented with options to add rooms (“+” icon), add photos (“camera” icon”) and send specs (“sheet” icon).

The user may select the master bath as the room to be viewed, and FIG. 3E depicts a screenshot of how categories within a room may be organized and images may be displayed. In this embodiment of the present disclosure, the user has selected the “master bath” and may be presented with categories including, but not limited to, countertops, flooring, hardware, inspirational images and interior doors. It should be appreciated that there may be some embodiments of the present disclosure where a user may be presented with only the categories where images have been placed; however, there may be other embodiments of the present disclosure where the user may be presented with all categories that may be associated with the room so that the user may elect to associate images with categories that have not been populated. In this embodiment of the present disclosure, thumbnails of the images associated with each category may be displayed. If the user wishes to look at a full view of the image, the user may click on the image that he/she would like to review. In this embodiment of the present disclosure, the user is again presented with the “sheet” icon and the “camera” icon so that he/she may create/send a specification sheet or upload a photo respectively.

FIG. 3F depicts a screenshot of an image that may have been selected by the user in FIG. 3E. In this embodiment of the present disclosure, the user may be presented with a larger view of the image. The user also may be presented with an icon, such as the tack depicted in FIG. 3F, that the user may select in order to add private notes about the image that may be included on a specification sheet. The user also may be presented with an icon, such as the star depicted in FIG. 3F, that the user may select to mark the image as a top choice. The user also may have the option to delete an image, such as by selecting the trashcan icon depicted in FIG. 3F. As depicted in FIG. 3F, the user may enter comments in the comments section that may be viewable by any users with whom the project is shared. Accordingly, if the user particularly likes the colors or the hardware depicted in the image, the user may include a comment to that effect so that his/her interior designer may get a better idea of what the user likes, should the user share the project with the interior designer.

In another embodiment, the invention can also relate to organization of various “projects” that are not related to the home building process. These projects may include recipes, hunting and fishing categories, family photographs, video and/or photographs from friends, clothing, maternity clothing, infant clothing, clothing accessories, interconnected projects and categories listed by location including but not limited to vacation or event places, party dish categories, décor or furnishing categories, lighting fixtures, personal data management including videos and/or photographs organized by project, and floral categories. It will be understood a person having skill in the art that photographs, data, text, or video can be in one “project” and also in other defined “projects.” The “projects” can be user-defined or administrator-defined. In additional each “project” can have sub-categories defined by a user or administrator. As part of the process, a graphical user interface is defined which includes a touchscreen or gesture-based interface. The graphical user interface may be curved, undulating, or flat in nature. The graphical user interface is configured to include a backdrop image or text-based system and then a dual-icon menu that is presented from a bottom-up presentation to the user. It will be understood that the graphical user interface can have one ore more icons presented on a menu and the presentation of the menu can be horizontal, left-to-right, right-to-left, or top-down. Upon display of the dual-icon menu, the user can either select to upload or otherwise add a photograph or video to an existing “project” or sub-category user a first icon or using the second icon, define a project which may include any number of sub-categories. For example, if the user has defined a project as family pictures some examples of sub-categories could include family pictures, vacation pictures, sports pictures, fishing pictures, grandkid pictures, self portraits “selfies”, and any combination of these sub-categories. Thus, in this method the user would 1) define a “project” and any subcategories through the graphical user interface; 2) allow a photograph to be uploaded or tagged to a specific project and/or sub-category; 3) allow for the photograph or video clip to be sorted based upon parameters from the “project” or other text-based searches; and 4) allow for multi-level searches of multiple “projects” and sub-categories to locate images or videos that are relevant to the search. Thus, with this highly-unique interface and process for defining projects based upon a plurality of parameters per each project specification combined with the ability to perform multi-level searches for data, the disclosed embodiment presents a powerful combination of ease of use and personal management functionality. It will be acknowledge that this process can occur in certain number of specific steps or in another preferred embodiment in any order determined by the software or user.

While systems and methods according to embodiments of the present disclosure have been described in the context of home building and remodeling projects, it should be appreciated that the systems and methods may be used for other applications without departing from the present disclosure.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. An Internet-based method for organization relating to a home building or remodeling project comprising:
identifying the home building or remodeling project from a list of one or more projects within a mobile application accessible via the Internet;
customizing a plurality of topics relating to the home building or remodeling project;
uploading one or more images or videos;
associating the one or more images or videos with at least one of the plurality of topics and at least one physical location within the at least one of the plurality of topics; and
viewing at least one view of the home building or remodeling project, the at least one view selected from the group comprising: a timeline view to show days that have passed since the home building or remodeling project began or days remaining before scheduled to be finished, a sanity view to provide other users working on the home building or remodeling project a real-time indication as to how a user feels about the home building or remodeling project, and a budget view.

2. The Internet-based method for organization of claim 1, wherein the plurality of topics is pre-loaded within the mobile application.

3. The Internet-based method for organization of claim 1, wherein customizing topics includes adding additional topics.

4. The Internet-based method for organization of claim 1, wherein the one or more images or videos are uploaded to the mobile application via a user's camera within his/her mobile phone or tablet.

5. The Internet-based method for organization of claim 1 further comprising:
viewing at least one of the one or more images or videos based on the plurality of topics or the at least one physical location; and
commenting on the at least one of the one or more images or videos.

6. The Internet-based method for organization of claim 1 further comprising:
sharing the home building or remodeling project with at least one other user via the mobile application accessible via the Internet.

7. The Internet-based method for organization of claim 1 further comprising:
producing at least one specification sheet based on the plurality of topics, the one or more images or videos, and the at least one physical location relating to the home building or remodeling project.

8. The Internet-based method for organization of claim 1, wherein the one or more projects are sorted between a user's projects and projects that have been shared with the user by at least one other user.

9. The Internet-based method for organization of claim 1, wherein the at least one physical location is selected from the group comprising:
entry, exterior, master bedroom, great room, master bathroom, guest bathroom, guest bedroom, kitchen, laundry room, mud room, spare bedroom, child's bedroom, and staircase.

10. The Internet-based method for organization of claim 1, wherein the plurality of topics is selected from the group comprising:
countertops, flooring, hardware, furniture, windows, ceiling treatments, floor plan sketches, glass and mirrors, lighting, inspirational images, and doors.

11. An Internet-based method for organization relating to a project comprising:
identifying the project from a list of one or more projects through a graphical user interface within a mobile application accessible via the Internet, wherein the project includes one or more sub-categories;
uploading one or more images or videos to the project;
tagging the one or more images or videos to the one or more sub-categories within the project; and
sorting the one or more images or videos based upon defined parameters for the project, wherein the project is selected from the group comprising: recipes, family photographs and/or videos, video and/or photographs from friends, clothing, accessories, vacation or event places, décor or furnishing categories, personal data management categories, and interconnected projects and categories.

12. The Internet-based method for organization of claim 11, wherein the one or more projects are user-defined or administrator-defined.

13. The Internet-based method for organization of claim 11 further comprising:
conducting multi-level searches of the one or more projects and the one or more sub-categories to locate one or more images or videos within the mobile application.

14. An Internet-based method for organization relating to a home building or remodeling project comprising:
identifying the home building or remodeling project from a list of one or more projects within a mobile application accessible via the Internet, wherein the one or more projects are sorted between a user's projects and projects that have been shared with the user by at least one other user;
customizing a plurality of topics relating to the home building or remodeling project;
uploading one or more images or videos, wherein the one or more images or videos are upload to the mobile application via a user's camera within his/her mobile phone or tablet;
associating the one or more images or videos with at least one of the plurality of topics and at least one physical location within the at least one of the plurality of topics;
viewing at least one of the one or more images or videos based on the plurality of topics or the at least one physical location; and
commenting on the at least one of the one or more images or videos.

15. The Internet-based method for organization of claim 14 further comprising:
viewing a timeline view of the home building or remodeling project to show days that have passed since the home building or remodeling project began or days remaining before scheduled to be finished.

16. The Internet-based method for organization of claim 14 further comprising:
viewing a sanity view to provide other users working on the home building or remodeling project a real-time indication as to how a user feels about the home building or remodeling project.

17. The Internet-based method for organization of claim 14 further comprising:
viewing a budget view to track and manage the budget relating to the home building or remodeling project.

18. The Internet-based method for organization of claim 14 further comprising:
sharing the home building or remodeling project with at least one other user via the mobile application accessible via the Internet.

19. The Internet-based method for organization of claim 14, wherein the one or more images or videos and comments originate from more than one source.
